(19) United States
(12) Patent Application Publication
(10) Pub. No.: US 2010/0025147 A1
(43) Pub. Date: Feb. 4, 2010

(54) DAMPING MATERIAL, METHOD OF FORMING THE DAMPING MATERIAL AND METHOD OF USING THE DAMPING MATERIAL

(75) Inventor: Abraham Kassa, Shelby Twp., MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/552,339

(22) Filed: Oct. 24, 2006

Related U.S. Application Data
(60) Provisional application No. 60/731,714, filed on Oct. 31, 2005.

(51) Int. Cl. E04B 1/84; E04B 1/82; C08K 3/38; B32B 15/08; B32B 7/12; B32B 25/10; B32B 5/18

(52) U.S. Cl. 181/290; 181/294; 524/405; 428/462; 428/343; 442/293; 428/319.9; 977/773

(57) ABSTRACT

A damping material is disclosed along with a method of forming and/or using the damping material. The damping material may be used in a variety of applications, however, has been found particularly useful in aerospace applications.

### CLAIM OF PRIORITY

This application claims the benefit of the filing date of U.S. Provisional Application No. 60/731,714 filed Oct. 31, 2005.

### FIELD OF THE INVENTION

The present invention relates to damping material and method of forming and/or using the damping material for an article of manufacture such an airplane.

### BACKGROUND OF THE INVENTION

It is typically desirable for particular locations within articles of manufacture such as passenger compartments or rooms within airplanes, buildings, automotive vehicles or the like to be comfortable for human beings. As such, it is often desirable for these locations to exhibit certain traits. For example, it is often desirable for such locations to exhibit relatively low amounts of noise. Moreover, it is often desirable to maintain the temperature of these locations within a desirable range.

For achieving such comfort, industry has developed materials (e.g., damping materials, insulating materials or the like), which assist in maintaining these traits. In the interest of continuing such innovation and development, the present invention provides a damping material that can block noise, can insulate or both and which exhibits one or more additional desirable characteristics. The present invention also provides a method of forming and or using the damping material.

### SUMMARY OF THE INVENTION

A layer of damping material is formed of a composition and the composition includes one or more of the following: 1) plasticizer (e.g., about 5 to about 15 percent by weight of the composition; 2) co-polymer (e.g., an ethylene copolymer in an amount of about 5 to 25 percent by weight of the composition; 3) thermoplastic rubber (e.g., about 5 to 25 percent by weight of the composition; pre-cured rubber (e.g., about 5 to 25 percent by weight of the composition); flame retardant (e.g., about 15 to about 75 percent by weight of the composition); and/or an effective amount of nano-particles (e.g., up to about 10 percent by weight of the composition). The copolymer can include vinyl acrylate, butyl acrylate or both. The thermoplastic rubber can include vinyl polyisoprene blocked with polystyrene blocks. The pre-cured rubber can include butyl rubber; The flame retardant can include a phosphate, a borate or a mixture thereof. Moreover, the plasticizer can include a paraffin. The layer of damping material, in one embodiment, is attached (e.g., adhesively bonded) to a fibrous layer.

The damping material and particularly the layer of damping material can be formed using various techniques such as extrusion. In use the damping material can be secured within an automotive vehicle, a building or the like. In one preferred embodiment the damping material is secured within an aircraft structure.

### BRIEF DESCRIPTION OF THE DRAWINGS

The features and inventive aspects of the present invention will become more apparent upon reading the following detailed description, claims and drawings, of which the following is a brief description:

FIG. 1 is a perspective view of an exemplary damping material of the present invention applied to an airplane.

FIG. 2 is a sectional view of an exemplary damping material according to an aspect of the present invention.

FIG. 3 is a sectional view of another exemplary damping material according to an aspect of the present invention.

### DETAILED DESCRIPTION

The present invention is predicated upon the provision of a damping material and methods of forming and using the damping material. The damping material will typically include, amongst other potential ingredients, one or any combination of the following: a plasticizer; one or more ethylene, acrylate or acetate copolymers; a thermoplastic rubber, a pre-cured rubber and flame retardant. The damping material of the present invention can be used, without limitation, for lessening sound, lessening vibration, insulation, combinations thereof or other uses.

When included, the plasticizer is usually at least about 1% more typically at least about 3% and even more typically at least about 5% and typically less than about 50%, more typically less than about 25% and even more typically less than about 15% by weight of the damping material. It is contemplated, however, that higher or lower amounts may be included within the scope of the present invention unless otherwise specifically stated.

It is generally contemplated that many different plasticizers may be used for the damping material and the plasticizer may be an admixture of multiple plasticizers. Preferred plasticizers are paraffinic. Examples of paraffinic plasticizers include those sold under the tradename CITGO (e.g., CITGO 320) and/or TUFFLO, commercially available from Citgo Petroleum Company, Houston, Tex. and/or Chemcentral Corporation, Chicago, Ill. Other potentially suitable plasticizer include, without limitation, phthalates, adipates, combinations thereof or the like.

When included, the one or more ethylene, acrylate or acetate copolymers or combinations thereof are usually at least about 1%, more typically at least about 3% and even more typically at least about 5% and typically less than about 60%, more typically less than about 35% and even more typically less than about 25% by weight of the damping material. It is contemplated, however, that higher or lower amounts may be included within the scope of the present invention unless otherwise specifically stated.

It is generally contemplated that many different ethylene, acrylate or acetate copolymers may be used for the damping material and the copolymer may be an admixture of multiple different copolymers. Preferred ethylene copolymers include, without limitation, acetates such as ethylene vinyl acetate (EVA), acrylates such as ethylene methacrylate (EMA), mixtures or copolymers of EVA and Butyl Acrylate, ethylene butyl acrylate, combinations thereof or the like. An example of an ethylene and/or acrylate copolymer is an ethylene butyl acrylate sold under the tradename Lotryl 35BA40, commercially available from Arkema Inc., which can be employed in the damping material in a ratio of between about 3:1 and about 1:3 (e.g., about 1:1) relative to another exemplary ethylene and/or acetate copolymer such as EVA, which is sold under the tradename ELVAX 460, commercially available from Dupont.

When included, the thermoplastic rubber is usually at least about 1% more typically at least about 3% and even more typically at least about 5% and typically less than about 60%, more typically less than about 35% and even more typically less than about 25% by weight of the damping material. It is contemplated, however, that higher or lower amounts may be included within the scope of the present invention unless otherwise specifically stated.

It is generally contemplated that many different thermoplastic rubbers or elastomers may be used for the damping material and the thermoplastic rubber may be an admixture of multiple thermoplastic rubbers. Preferred thermoplastic rubbers include, without limitation, nitrile rubbers, styrenic rubbers, combinations thereof or the like. One preferred thermoplastic rubber is a styrene block copolymer (e.g., SBS) (e.g., vinyl polyisoprene blocked with polystyrene blocks). One example of a preferred thermoplastic rubber is a block copolymer that includes a styrene block coupled with one or more of the following blocks: vinyl-polyisoprene; polyisoprene; hydrogenated vinyl-polyisoprene; and/or hydrogenated polyisoprene, sold under the tradename HYBRAR, commercially available from Kuraray.

When included, the pre-cured rubber is usually at least about 1% more typically at least about 3% and even more typically at least about 5% and typically less than about 60%, more typically less than about 35% and even more typically less than about 25% by weight of the damping material. It is contemplated, however, that higher or lower amounts may be included within the scope of the present invention unless otherwise specifically stated.

It is generally contemplated that many different pre-cured rubbers or elastomers may be used for the damping material and the pre-cured rubber may be an admixture of multiple pre-cured rubbers. Preferred pre-cured rubbers include, without limitation, nitrile rubbers, styrenic rubbers, butyl rubbers, combinations thereof or the like. One example of a preferred butyl rubber is sold under the tradename KALAR 5280, commercially available from Royal Elastomer.

When included, the flame retardant is usually at least about 3% more typically at least about 25% and even more typically at least about 35% and typically less than about 90%, more typically less than about 75% and even more typically less than about 50% by weight of the damping material. It is contemplated, however, that higher or lower amounts may be included within the scope of the present invention unless otherwise specifically stated.

It is generally contemplated that many different flame retardants may be used for the damping material and the flame retardant may be an admixture of multiple flame retardants. Preferred flame retardant include, without limitation, halogenated (e.g., chlorinated or brominated) polymers, ammonium phosphate, zinc borate, combinations thereof or the like. An example of an ammonium phosphate ((e.g., NH₄PO₃)ₙ, N≧100) is sold under the tradename JLS-PNP1C, commercially available from Hangzhou JLS Flame Retardants Chemical Co, Ltd., which can be employed in the damping material in a ratio of between about 30:1 and about 1:1 (e.g., about 8:1) relative to an exemplary zinc borate (e.g., 2ZnO.3B₂O₃.3.5H₂O), which is sold under the tradename FIREBRAKE ZB, commercially available from Luzenac. While halogenated flame retardants can be employed, in preferred embodiments, the damping material is substantially or entirely without halogenated flame retardants and/or without flame retardants including chlorine or bromine atoms.

The damping material can also include fillers, typically in relatively small amounts, although not required. Nano-fillers or nanoparticles (e.g., nanoclay) are generally preferred. Additionally, relatively small amounts (e.g., about 0.01% to about 5% by weight) of stearic acid and/or zinc stearate may be included in the damping material.

It is additionally contemplated that a blowing agent, curing agent or both may be added to the damping material or the damping material may be substantially without any blowing agent or curing agent. When used, the blowing agent is typically employed for foaming or forming a foam of the damping material while a curing agent is typically employed for thermosetting the material.

### Example 1

A formulation is prepared by admixing in a suitable mixer the ingredients of the following Table 1.

TABLE 1

| | |
|---|---|
| Paraffinic plasticizer | 11 parts by weight |
| Ethylene co-polymer | 12 parts by weight |
| Styrene block co-polymer | 17 parts by weight |
| pre-cured butyl rubber | 15 parts by weight |
| flame retardant | 45 parts by weight |

The above formulation is provided as an example. Since it is merely exemplary, it is contemplated that the weight percents of the various ingredients may vary by ±50% or more or by ±30% or ±10%. For example, a value of 50±10% is a range of 45 to 55. Moreover, ingredients may be added or removed from the formulations.

Formation of the damping material typically including intermixing of the ingredients in a preferably substantially homogeneous material and formation of the material into a desired shape such as a layer or otherwise. Generally, the ingredients may be intermixed in a unit such as an extruder (e.g., a single or twin screw extruder) or a standard mixer such as a shaw mixer and may be dry blended, melt blended or otherwise intermixed may be shaped by a molding machine, an extrusion die, a die cut or the like.

In one preferred embodiment, the damping material or ingredients thereof are fed to an extruder which extrudes the damping material. After extrusion, the material is fed to a calendar mill that forms the extruded material into a layer of desired thickness, which can be varied depending upon concerns such as cost and application.

The damping material is generally used by contacting the material with one or more substrates. The damping material has been found particularly useful for aerospace applications (e.g., application to substrates within or to be located within airplanes) although the material may also be used in conjunction with other articles of manufacture such as transportation vehicles (e.g., automotive vehicles). The damping material can be employed in conjunction with a constraining layer such a fiber (e.g., glass, polymer, carbon, natural or other fiber) layer that is typically made in to a cloth, weave, roving or the like or may another layer such as a polymeric layer, a metal foil layer or the like. It is also contemplated that the damping layer may be employed between panels (e.g., metal body or other panels) of a transportation vehicle such as an airplane or automotive vehicle.

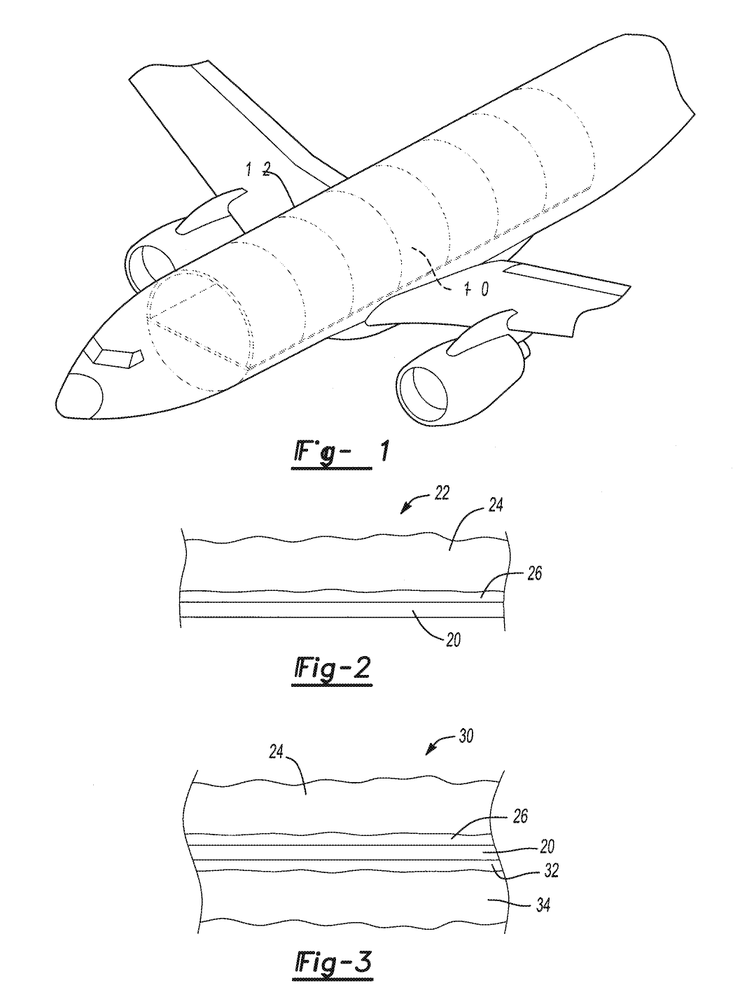

Generally, the damping material may be used in various locations of an airplane such as the wings, the cockpit, panels within the passenger compartment of the airplane, combinations thereof or the like. In a preferred embodiment, the damping material is located between the outer fuselage of the airplane and interior panels defining the passenger compartment. Such an embodiment is illustrated in FIG. 1. As shown, the damping material 10 is generally coextensive with the outer fuselage 12 of the airplane.

When used, particularly for airplanes, the damping material will be a layer laminated with one or more (preferably multiple) layers of different material, although not required. The different materials can be fibrous materials, adhesives, combinations thereof or the like. In one preferred embodiment, the damping material is sandwiched between two or more layers of different materials. While it is contemplated that the damping material can be employed in all types of airplanes, the material is particularly desirable for providing damping, insulation or both to airplanes (e.g., multiple (15, 35, 40 or more) passenger airplanes, jets or both) that are designed to fly at altitudes greater than 2000, 3000 or 3300 ft and in atmospheres having temperatures below 10° C., −10° C., —40° C. or even −60° C.

### Example 2

The formulation of Table 1 in FIG. 2 is used to form a damping layer 20 that is incorporated in a structure 22 (e.g., a damping laminate) that includes a first blanket or fibrous layer 24 (e.g. a NOMEX blanket) a first adhesive layer 26 (e.g., available from 3M under the designation 9375) bonded to the first blanket fibrous layer 24, and the damping layer 20.

### Example

The structure 30 of Example 2 in FIG. 3 is adapted to further include a second adhesive layer 32 (e.g., available from 3M under the designation 9375) bonded to the damping layer 20, and a second blanket layer 34 (e.g., a NOMEX blanket).

It should be understood that layering can continue such that there are multiple layers of damping material and 1, 2 or more adhesive layers and/or fibrous layers corresponding to each damping layer.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A damping material, comprising:
a layer of damping material, the layer being form of a composition that includes:
i. plasticizer;
ii. co-polymer;
iii. thermoplastic rubber; and
iv. a flame retardant including a borate.

2. A damping material as in claim 1 wherein the composition further includes a pre-cured rubber in an amount of about 5 to 25 percent by weight of the overall composition.

3. A damping material as in claim 1 wherein the flame retardant is zinc borate and is present in an amount of about 15 to about 75 percent by weight of the overall composition

4. A damping material as in claim 1 wherein the composition further includes and effective amount of nano-particles in an amount up to about 10 percent by weight of the overall composition.

5. A damping material as in claim 1 wherein the co-polymer includes ethylene and acrylate.

6. A damping material as in claim 1 wherein the co-polymer includes ethylene and vinyl acrylate, butyl acrylate or both.

7. A damping material as in claim 1 wherein the thermoplastic rubber includes vinyl polyisoprene blocked with polystyrene blocks.

8. A damping material as in claim 2 wherein the pre-cured rubber is butyl rubber.

9. (canceled)

10. A damping material as in claim 1 wherein:
i. the plasticizer includes a paraffin;
ii. the damping material is attached to a metal substrate or a composite substrate or an an adhesive.

11. A damping material as in claim 1 wherein the layer is adhesively bonded to a fibrous layer.

12. A damping material as in claim 11 wherein the fibrous layer is in the form of a blanket.

13. A damping material as in claim 1 wherein the layer of damping material is at least partially impregnated in a porous substrate.

14. A damping material as in claim 1 wherein the layer of damping material is secured within an aircraft structure.

15. (canceled)

16. (canceled)

17. A damping material as in claim 15 wherein the damping material including the layer of damping material and a fibrous layer are secured within a aircraft structure.

18. A damping layer, comprising:
a layer of damping material, the layer being form of a composition that includes:
i. plasticizer in an amount of about 5 to about 15 percent by weight of the overall composition;
ii. ethylene co-polymer in an amount of about 5 to 25 percent by weight of the overall composition, the copolymer including ethylene;
iii. thermoplastic rubber in an amount of about 5 to 25 percent by weight of the overall composition, the thermoplastic rubber including vinyl polyisoprene blocked with polystyrene blocks; and
iv. pre-cured rubber in an amount of about 5 to 25 percent by weight of the overall composition, the pre-cured rubber being a butyl rubber;
iii. a zinc borate flame retardant in an amount of about 15 to about 75 percent by weight of the overall composition; and
v. an effective amount of nano-particles in an amount up to about 10 percent by weight of the overall composition, the nano-particles including nanoclay;
a first fibrous layer adhered to a first side of the layer of damping material and a second fibrous layer adhered to a second side of the layer of damping material, the damping layer being adhered to the first and second fibrous layers with a methacrylic adhesive;
wherein the damping layer is secured within an aircraft structure.

19. A damping layer as in claim 18 wherein the flame retardant includes a mixture of ammonium phosphate and zinc borate, and the weight ratio of the ammonium phosphate and zinc borate is from about 20:1 to about 5:1.

20. A damping layer as in claim 19 wherein the flame retardant is present in an amount up to about 60 percent by weight of the overall composition, the weight ratio of the ammonium phosphate and zinc borate is about 8:1, the plasticizer is present in an amount of about 8 to 12 percent by weight of the overall composition, the polymer including ethylene is present in an amount of about 10 to 16 percent by weight of the overall composition, the thermoplastic rubber is present in an amount of about 12 to 20 percent by weight of the overall composition; and wherein the pre-cured rubber is present in an amount of about 12 to 20 percent by weight of the overall composition, and the nanoparticle is present in an amount of up to about 3 percent by weight of the overall composition.

21. A damping layer, consisting essentially of:
a layer of damping material, the layer being form of a composition that includes:
i. plasticizer in an amount of about 5 to about 15 percent by weight of the overall composition;
ii. ethylene co-polymer in an amount of about 5 to 25 percent by weight of the overall composition, the copolymer including ethylene;
iii. thermoplastic rubber in an amount of about 5 to 25 percent by weight of the overall composition, the thermoplastic rubber including vinyl polyisoprene blocked with polystyrene blocks; and
iv. pre-cured rubber in an amount of about 5 to 25 percent by weight of the overall composition, the pre-cured rubber being a butyl rubber;
v. a zinc borate flame retardant in an amount of about 15 to about 75 percent by weight of the overall composition;
vi. an effective amount of nano-particles in an amount up to about 10 percent by weight of the overall composition, the nano-particles including nanoclay;
vii. an ammonium polyphosphate flame retardant;
viii. an ethylene vinyl acetate copolymer; and
a first fibrous layer adhered to a first side of the layer of damping material and a second fibrous layer adhered to a second side of the layer of damping material, the damping layer being adhered to the first and second fibrous layers with a methacrylic adhesive;
wherein the damping layer is secured within an aircraft structure.
